(19) United States
(12) Patent Application Publication
(10) Pub. No.: US 2013/0228543 A1
(43) Pub. Date: Sep. 5, 2013

(54) PET BLOW MOULDING METHOD FOR PRODUCING BLOW MOULDED PET CONTAINERS AND SUCH A CONTAINER

(71) Applicants: Steven Paul Jordan, Slough (GB); Hendrik Willem van Es-Boting, Rijswijk (NL)

(72) Inventors: Steven Paul Jordan, Slough (GB); Hendrik Willem van Es-Boting, Rijswijk (NL)

(21) Appl. No.: 13/883,292

(22) PCT Filed: Oct. 25, 2011
(86) PCT No.: PCT/EP2011/068650

§ 371 Date: May 3, 2013

(30) Foreign Application Priority Data
Nov. 11, 2010 (EP) 10190913.3

(51) Int. Cl. B29C 49/42; B65D 1/02

(52) U.S. Cl. CPC B29C 49/42; B65D 1/023
USPC 215/40; 264/523

(57) ABSTRACT

A PET blow moulding method is provided for producing a blow moulded PET container (10) suitable for snap fitting a base cap (60) and having an axial centre for enabling a blow molding process. PET preform (20,30) is inserted into a mould shaped to an inverse of the snap-fit PET container. Such a blow moulded PET container (10) is also disclosed. The PET preform is narrowed on a distal end side shaped for forming a knob portion (1) that is connected to a liquid compartment (3) of the PET container (10) via a neck portion (4), so as to form the knob having an inwards receding snap zone (43) formed by a curvature in the neck portion (4).

### FIELD OF INVENTION

The present invention generally finds application in the field of PET blow moulding for producing blow moulded PET containers suitable for snap fitting with a base cap. This invention further relates to a blow moulded PET container suitable for snap fitting with a base cap and a base cap forming a stable connection therewith.

### BACKGROUND OF INVENTION

A blow moulded PET container is a container that can form a snap-fit connection with a secondary piece, hereinafter referred to as ‘base-cap’. To form this connection the container and base-cap are both provided with ‘snap-fit portions’ that have a functional form definition to allow the ‘snapping’ process. The form definitions may comprise e.g. an inwards receding snap zone on the container that can hold on to a corresponding matching barrier on the base-cap. The snap-fit connection is formed when the respective snap-fit portions are pushed together thereby overcoming a threshold force that is related to the size and shape of the barriers and the respective rigidities of the snap-fit components. When the threshold force is overcome the base-cap and container may snap together and fit to form a single connected structure.

The action of forming or releasing a connection between the container and the base-cap will be referred to as ‘snap-on’ and ‘snap-off’, respectively. The force required to perform these actions will be referred to as the ‘connection’ and ‘release’ forces, respectively. Depending on the application of the container, a particular connection and/or release-force may be desired. For example, a snap-fit cap on a drinking bottle that requires a user to perform frequent snap-on and snap-off actions will usually have a release-force that is large enough to prevent accidental opening of the bottle, but small enough to allow the user to remove the cap (snap-off), with relative ease, for drinking. Similarly, the connection force should not exceed a value where the user would have difficulty in closing the cap on the bottle (snap-on). The connection and release forces for such a drinking bottle application thus lies in a specific range.

The ease or difficulty, with which a snap-off action can be performed, either voluntary or accidental, will be referred to as the ‘stability’ of the connection. If the release force needed to break the connection is high, the stability will be correspondingly high. A connection of certain stability may thus refer to a specification for a minimum threshold value for the release force that must be delivered to break the connection. The desired release threshold may depend on the application. In the aforementioned drinking bottle, the connection should be stable enough to prevent accidental release.

In another type of snap-fit connection, referred to as a ‘permanent’ snap-fit connection, it is not required and/or desired that the snap-fit can be released at all. A goal of the permanent snap-fit is simply to form a stable connection between two elements, in this case the container and the base-cap, without the necessity for release. For a permanent snap-fit connection, only a minimum release force needs be specified which force is generally higher than that of a frequent-release snap-fit connection, such as the aforementioned drinking bottle.

A snap-fit connection is formed when a base-cap and container are pushed together and moved over the barriers of the respective snap-fit portions. The barrier on the container may be formed e.g. by a radially outward increase of the cross-section in a part of its snap-fit portion. This increase may comprise e.g. a knob or ridge in the snap-fit portion. The base-cap has a matching, usually reciprocal form definition, e.g. a ring or hole that can push and clamp radially inward onto the snap-fit portion of the container. When the base-cap is moved over the barrier it will generally arrive in a part of the container's snap-fit portion that may be characterized as a ‘neck’, i.e. a portion with an inwards receding snap zone that has a lower cross-section than the maximum cross-section of the snap-fit portion, e.g. lower than the knob or ridge. When the radially inward pushing portion of the base-cap traverses the increased cross-section and arrives at the neck of the snap-fit portion, the radially inward pushing forces that result from the elastic stiffness of the base-cap and the radially outward pushing forces that result from the snap-fit portion of the container may relax. The result is that the base cap and container are snapped or locked together forming a stable connection.

As mentioned, the stability of the connection is related to the release force that is needed to overcome the respective barriers of the container and/or base-cap. The release and connection forces may generally depend on the form definitions of the snap-fit portions of the container and/or base-cap and the rigidities of the materials and specific forms (e.g. thickness) used to construct these portions.

The connection or release forces required to form or break the connection between the snap-fit components may be adjusted by the size of the barrier and/or the steepness of the barrier. Increasing the barrier increases the elastic deformation in the materials when the base-cap is pulled from the container. The elastic forces, pushing to counteract this deformation, result in increased frictional and/or elastic forces on the snap-fit components. Furthermore, the differential of the increase of the barrier in the direction of movement (i.e. the gradient of the cross-section) is related to the potential energy differential that results from elastic deformation of the materials along the movement trajectory. The forces that are externally exerted to release or connect the base-cap and container need to overcome the elastic forces that push the base-cap and container in a direction so as to lower the potential energy of the elastic deformation, which direction may be opposite to the external forces when pushing or pulling the components up a barrier.

A high stability connection is thus formed when the respective barriers comprise an angle that is steep in the direction of the release force, i.e. the direction in which the base-cap is moved with respect to the container to release the connection. For angles that are below the perpendicular angle the barriers may slide over each other while the container and/or base-cap may undergo a certain degree of deformation which degree may also depend on the respective rigidities of either material. The force that is exerted at each part of the release trajectory needs to overcome the friction and/or elastic forces of the materials that clamp the snap-fit portions together and/or push the base-cap back onto the container.

Another factor that plays a role in the stability of the connection between the snap-fit components is the material that is used to construct these components. In particular, the connection between the container and base cap will be more stable if the materials used for either component is well defined in its form. However, the choice of the material used may depend on other factors such as cost, durability, and aesthetic appearance.

Conventionally for packing liquids such as gels, cleaning products or other body or household care products, polypropylene material is used in a blow moulding process as a manufacturing material since this is well manufacturable and suitable for mass production. However, to improve clarity of the container, which is in some instances considered visually more attractive and at the same time to reduce costs, it is desired to use PET stretch blow moulded bottles to pack such products.

In particular, it is desired to provide such bottles having a hook on the side away from a bottle valve opening, so that the bottle can be hanged from a bar e.g. in the shower. Therefore, preferably a hook has to be provided to the base cap. The presence of the hook and the corresponding dimensioning of the cap will limit the possibilities for providing a snap fit connection to a knob, because the knob needs suitably small dimensioning to accommodate for the hook that will preferably be provided flush to the knob, so that the hook can be wrapped around it.

A desired behaviour of providing excessive force to the hook is uncapping of the base cap from the knob, which imposes further constraints on the snap behaviour. In particular, the snap-off force needs to be lower than a tear-off force of the film hinge, in such way that always a force snapping is guaranteed. Such snap off-behaviour will require higher curvature details, which in the conventional process will be difficult to attain.

In a production process using Injection Stretch Blow Moulded (ISBM) PET technology, the required detailing in the ridges will be attained with more difficulty because the radii that can be reached are much larger than with polypropylene blow molding.

Therefore, in the current application it is desired to create a container from PET that can form a snap-fit connection with a plastic base-cap. Polyethylene terephthalate, commonly abbreviated PET, PETE, or the obsolete PETP or PET-P, is a thermoplastic polymer resin of the polyester family. PET has advantageous properties of being lightweight, strong, impact-resistant, and a good gas and moisture barrier. Furthermore PET is naturally colorless with a high transparency. These properties make PET suitable e.g. for the construction of a sturdy, transparent container holding a liquid substance.

An advantageous process for producing a container from PET is called ‘blow molding’, also known as blow forming. This process is generally used to create hollow objects from thermoplastics. The blow molding process begins with the creation of a preform. This preform is a tube-like piece with a hole in one end, created by the melting of plastic (in this case PET) in the shape of the preform.

This preform may be heated and is expanded using pressurized gas, e.g. air. In this expansion, parts of the preform may be pressed against a mold cavity to create a particular form definition. The pressure is held until the plastic cools and hardens. Afterwards the mold may open up and the product ejected.

As mentioned problem arising in the conventional PET blow molding process is that it is hard to create a form definition comprising a ‘sharp’ (i.e. high curvature/low radius) feature in the product. In particular when such a sharp feature is attempted, the wall of the material comprising that feature may be inadequately stretched to meet acceptable curvature parameters. This may be understood as follows. As the preform is first expanded, it generally keeps a uniformly decreasing wall thickness. When parts of the preform then hit the mold cavity, those parts will stop expanding thus also stopping the stretching of the preform wall at those parts. Other parts that have not yet encountered a wall cavity will keep on expanding and getting stretched. The discrepancy between the expansions of different parts is most prominent at the position of a sharp or high curvature feature, because the preform needs to extend partly into the cavity feature while the surrounding parts have stopped expanding against the surrounding wall.

In view of the above discussion about the need for the creation of a steep or sharp barrier in a snap-fit connectable container there has thus far been a problem when attempting to efficiently create a snap-fit PET container in a blow molding process using standard industry tolerances and processes.

### SUMMARY OF INVENTION

In a first aspect there is provided a PET blow moulding method for producing a blow moulded PET container suitable for snap fitting a base cap and having an axial centre for enabling a blow molding process. The method comprises the steps of inserting a PET preform into a mould shaped to an inverse of the snap-fit PET container and providing pressurized gas supply into the PET thereby expanding the PET preform into the mould in a blow moulding step thereby attaining the shape of the PET container. The PET preform has a narrowed distal end for forming a knob portion that is connected to a liquid compartment of the PET container via a neck portion; so as to form the knob having an inwards receding snap zone formed by a curvature in the neck portion having a curvature radius smaller than 2.5 mm with a tolerance smaller than 0.25 mm and distanced from the axial centre with an average smallest diameter ranging between 19 mm and 30 mm such that a plastic base cap can be snapped onto the knob and form a stable connection therewith.

In a second aspect, a blow moulded PET container suitable for snap fitting a base cap is provided according to the method.

Without being bound by theory the following is asserted. Because the preform has a narrowed distal end, an asymmetric expansion of the material into the reciprocal knob space will occur that will induce locally enhanced stretching in the neck portion, thereby resulting in a better form definition with a tolerances that in an acceptable range.

### BRIEF DESCRIPTION OF DRAWINGS

These and other aspects are described in more detail with reference to the drawings wherein:

FIG. 1 shows a shape for a blow moulded PET container;

FIG. 2 shows a preform with a recessed endcap;

FIG. 3 shows a preform with a conical shape

FIG. 4 shows further details of the blow moulded PET container;

FIG. 5 shows snap zone geometry of the container of FIG. 4;

FIG. 6 shows a schematic view of an embodiment with a base cap and hook; FIG. 6A in mounted form and FIG. 6B a bottom view of the base cap.

### DETAILED DESCRIPTION OF EMBODIMENTS

Other objects, features and advantages will occur from the following description of particular embodiments and the accompanying drawings. These embodiments are described in sufficient detail to enable those skilled in the art to practice the presently disclosed systems and methods, and it is to be understood that other embodiments may be utilized and that structural and logical changes may be made without departing from the spirit and scope of the present system. In the description, identical or corresponding parts have identical or corresponding numerals. The exemplary embodiments shown should not be construed to be limitative in any manner and serve merely as illustration. The following detailed description is therefore not to be taken in a limiting sense, and the scope of the present system is defined only by the appended claims. Moreover, for the purpose of clarity, detailed descriptions of well-known devices, circuits, and methods are omitted so as not to obscure the description of the present system.

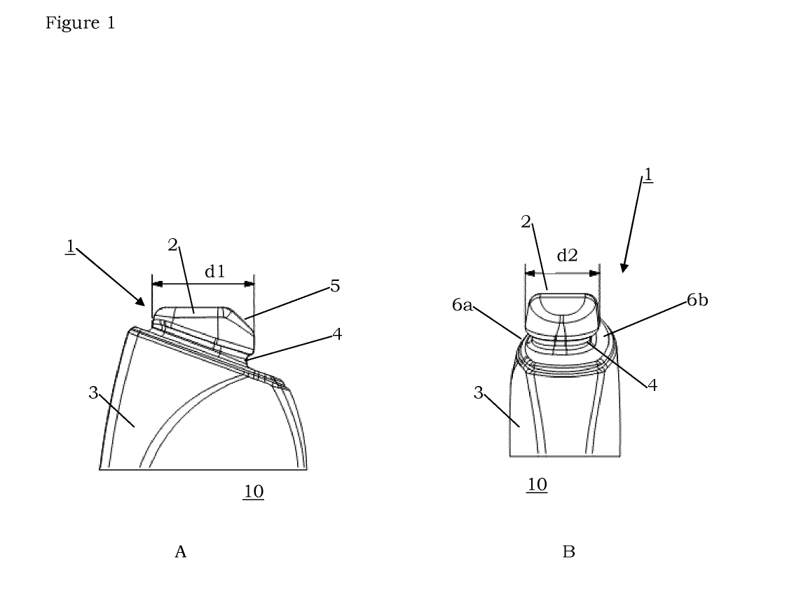

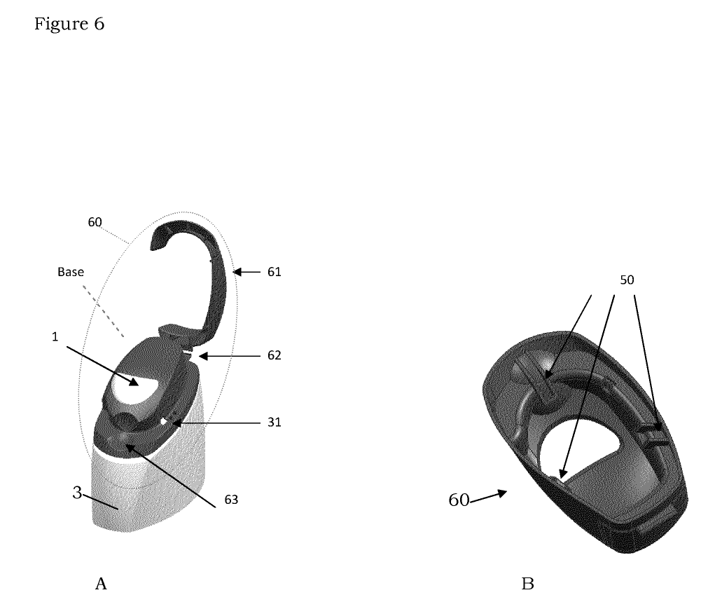

FIG. 1 schematically shows a shape for a blow moulded PET container 10 in side view (A) and front view (B). A knob form 1 is provided for snap fitting a base cap (See FIG. 6). The PET container 10 comprises a bottle part or liquid compartment 3 and a knob portion 1 that is connected to the liquid compartment 3 via a neck portion 4. A typical side to side distance d1 FIG. 1A ranges between 30 and 40 mm; a typical front to back distance d2 ranges between 20 and 30 mm.

An average smallest diameter of the neck portion 4 ranges between 19 mm and 30 mm. In the following, disclosure will be provided to have a plastic base cap (see FIG. 6) snapped onto the knob and form a stable connection therewith. The knob 1 has a top face 2 a sloped sidewall 5 in the direction of the longest dimension d1 for providing rigidity to the knob and for ease of snapping the base cap onto the PET container. The shape of the knob 1 gives sufficient space for the base cap and the hook to be wrapped around the knob. This may result in an asymmetric design with respect to the axial axis of the container, wherein a side 6b of the knob 10 provides room for a hook, and whereas the opposing side 6a doesn't.

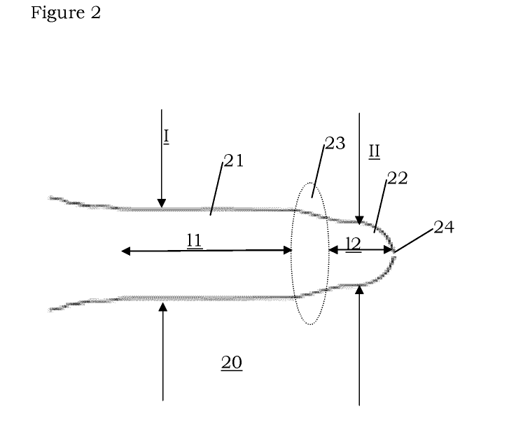

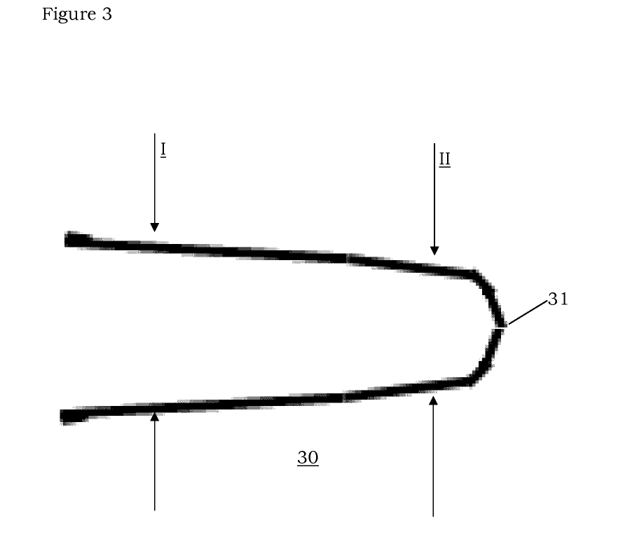

FIGS. 2 and 3 show embodiments of preforms with narrowed distal end side. In particular, FIG. 2 shows a preform 20 with a recessed endcap according to a first embodiment; and FIG. 3 shows a preform 30 with a conical shape according to a second embodiment. Preform samples were produced on an injection molding machine with a single cavity. The resin was dried until a moisture level of less than 50 ppm was achieved. The resins were injected into the designed preforms via injection points 24 and 31 for embodiments 20 and 30 respectively. The PET preform consists of non-crystallized or amorphous PET. Amorphous PET is transparent. Around the injection point, the PET material may have local different random properties resulting from the injection molding process resulting in different material characteristics and different material shrinkage. This difference in shrinkage may cause differences in product dimensions. For instance, the area around the injection point may suffer from random properties due to the injection moulding of the preform. Next, a stretch-rod that is used in the stretch blow molding process may have an influence on the way the material around the injection point is prevented to be stretched by holding it down against the bottom of the blow mold. In addition the centre bottom material around the injection point hasn't got the same distance to be stretched to as the material in the middle body of the bottle shape. The path towards the mold surface is shorter.

Another factor negatively contributing the dimensional tolerance range is the way the PET material is touching the mold wall. Especially the material that has to be blown into the inner corners of the mold as in the radius R at the bottom of the knob, isn't touching the mold in a consistent way. Due to the above mentioned different material behaviours and the varying area of the material touching of the mold wall, the product radius dimension will subject to a large dimensional tolerance range.

The injection moulding conditions were developed to minimize loss and to produce as clear and stress free a preform as possible using the preform shapes as described which result in a feasible dimensional tolerance range allowing a proper snap fit of the base cap.

In particular, in the stretch blow moulding process the preform is first stretched along the length of the preform by a stretch-rod. The stretch-rod moves the area of the preform with the injection point down and pinches it down against the bottom of the blow mould. In the following blowing step the preform is then blown out against the mould walls where it cools instantly and gets its rigid shape.

The material that is furthest away from the centre is stretched the most and will get a semi-crystalline structure where little crystals are formed between the stretched molecules. In this structure the PET material gains its strong structural properties. The rapid cooling prevents the PET material to form larger crystals which would cause the material to become non-transparent.

Two PET resins with a different IV have been used to inject mould the preforms. The IV is a known industrial standard and is an indicative value of the stiffness of PET resin. The objective of this resin trial was to observe the influence of the IV on the knob shaping during blowmoulding. The IV ranges between 0.74 and 0.82 and can be commercially obtained under the trademark name as Cleartuf P82 PET resin (c) from M&G Polimeri Italia (IV=0.82) and Cleartuf P76 PET resin (c) from M&G (IV=0.74). It was found that IV was not significant.

The recessed end cap preform 20 has a proximal part 21 that is generally cylindrically formed with a first length 11 and a first average diameter I resulting in a first round circumference with a first circumferential length. Divided from the proximal part 21 by a transition zone 23, the recessed endcap 22 having an axial length 12 has a second diameter II resulting in a round circumference with a second circumferential length and wall thickness. The recessed diameter II is typically less than 90% of the first circumferential length, more preferably 70-80% of the first circumferential length. In the endcap 22 the wall thickness is preferably reduced with a similar reduction factor.

The conical preform 30 does have a sloped form between a first diameter I and a second diameter II. Similar to the first embodiment, the first average diameter I results in a first round circumference with a first circumferential length and the second diameter II results in a round circumference with a second circumferential length. Typical lengths of 11, range between 40 and 60 mm, typical lengths of 12 range between 10 and 20 mm. The recessed diameter II is typically less than 90% of the first circumference.

It is found that the conical preform 30 gives bigger knob dimensions of Front-to-back length whereas the recessed preform 20 is better for side-to-side length dimensions. In conclusion, the optimized process of recessed end-cap preforms give better results of the knob dimensions. Fewer defects on the produced containers were observed. These last containers have thicker knob that seems to help to shape this area.

The center of the knob 1 provided by the inverse mould should be oriented directly above the center of the preforms 20, 30. When stretching and preblowing the preforms 20, 20, the chance of the material hitting the wall of the mould at the narrowest location in the neck portion 4 is then minimal. Measured tear off values are above a minimum required force of 30N.

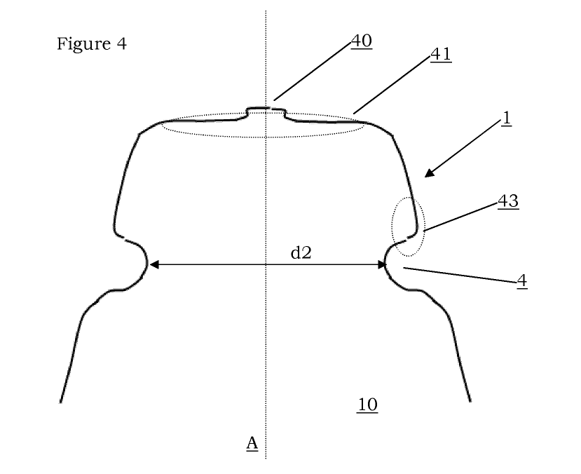

FIG. 4 shows further details of the blow moulded PET container with the knob 1 with a general ‘mushroom’ shape as in the side view of FIG. 1B. For enabling the blow moulding process the container 10 has an axial centre A defined by the preforms 20, 30. In the method of this disclosure, the PET preform 20, 30 is inserted into a mould shaped to an inverse of the snap-fit PET container 10 prior to providing pressurized gas supply into the PET preform thereby expanding the PET preform into the mould in a blow moulding step thereby attaining the shape of the PET container 10. The center of the knob 1 is directly above the center of the preform 20, 30. When stretching and preblowing the preform, the chance of the material hitting the wall of the mould at the narrowest location is then minimal.

In particular, in the shown embodiment, the blow moulding method results in a container 10 with a knob 1 having a precursor central 40 spot on the end face 41, for allowing the plastic base cap to cover said central spot 40 when snapped onto the knob 1. Preferably, the knob top surface 41 is flat to create a good surface for the preform 20, 30 to land on in the blow moulding process. A typical flat top area 41 of the knob ranges between 225-625 mm̂2.

In addition, the shape has an inwards receding snap zone 43 that that is sharp enough to have the base cap click-on. A typical dimensioning of the curvature is to provide a radius r below 2.5 mm, preferably around 1.7 mm, and to blowmould a mushroom shape with tolerances of less than 0.25 mm. In order to avoid contact between preform 20, 30 and mould during blowmoulding a minimum diameter is 19 mm in the neck area 4.

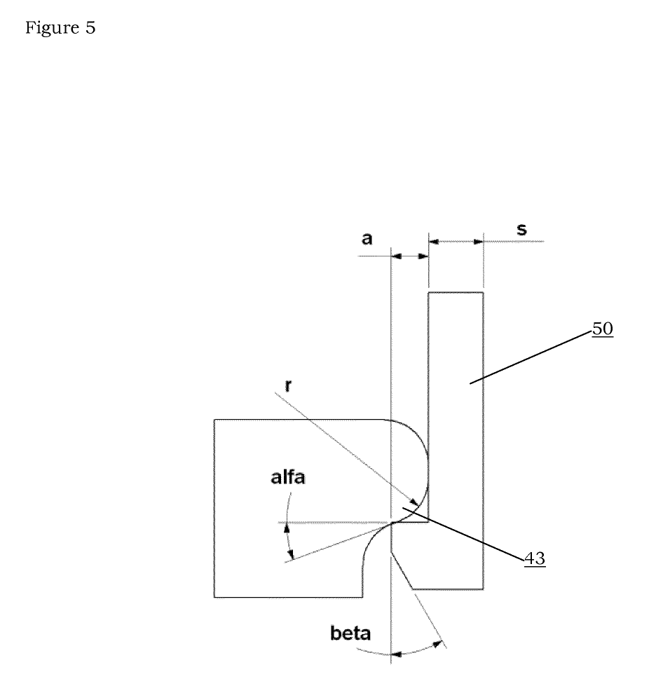

FIG. 5 shows in more detail the snap zone geometry 43 of the container of FIG. 4 for a permanent connection. The principle of permanent clicking is based on locking a snapfinger 50 under an undercut formed by snap zone 43. If the angle of the undercut is 90 degree it will be understood that the forces the snapfinger 50 can withstand are high. In all other cases the angle and the friction between the snapfinger 50 and the mating material in zone 43 becomes important for the resistance. Due to the ISBM blow moulding process the snapzone 50 has a certain radius r. Part of the proof is to define the minimum radius possible to make on an industrial basis. The reason for trying to get a radius as minimal as possible is to get maximum design freedom and minimum deformation of the basecap during capping. To be able to click on a “undercut” with a large radius, the clickfingers 50 will have to bend far to be able to grab far enough around the radius. Looking at the figure, for a given value of alfa and r, the value for “a” can be calculated based on a friction coefficient of about 0.35, from which it can be derived that for a tear off angle alfa below 20 degrees, the base will lock on the dome. The value for “a” is therefore only depending on the radius r. The smaller this radius, the smaller the value for “a”, and the less distance the click has to travel when applying the hook on the bottle, giving less stress and application forces. A typical tear of force to tear the base cap from the container is well above 30N; wherein the tear off force of the base cap is preferably designed to be lower than the force for breaking the filmhinge (see FIG. 6).

FIG. 6 shows a schematic view of an embodiment with a base cap 60 and hook 61 connected by film hinge 62; FIG. 6A in mounted form and FIG. 6B a bottom view of the base cap 60. To unlock the hook 61 from base cap 60 a cut out 63 is provided in the base cap to provide room for finger grip.

In the bottom view of FIG. 6B the snap fingers 50 are illustrated in more detail, which form protrusions correspondingly shaped to the snap zone 43.

The knob 1 has a smaller maximum cross-section than the compartment 3 such that the base cap 60 and compartment 3 can form a smooth transition along an outer connecting diameter 31. Two types of base caps were tested. Some base-cap produced from homopolymer were tested for most of the tests. Some other base-caps produced with a copolymer have been tested for the drop test and the tear-off test. The copolymer helped to improve the impact resistance during the drop test but it does also decrease the resistance to tear-off.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and by those skilled in the art in practicing the claimed invention, from a study of the drawings, the disclosure, and the appended claims.

In the claims, the word “comprising” does not exclude other elements or steps, and the indefinite article “a” or an does not exclude a plurality. A single unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A PET blow moulding method for producing a blow moulded PET container suitable for snap fitting a base cap and having an axial centre for enabling a blow molding process; the method comprising the steps of:
(a) inserting a PET preform into a mould shaped to an inverse of the snap-fit PET container;
(b) providing pressurized gas supply into the PET thereby expanding the PET preform into the mould in a blow moulding step thereby attaining the shape of the PET container; and
(c) wherein the PET preform is narrowed on a distal end side shaped for forming a knob portion that is connected to a liquid compartment of the PET container via a neck portion; so as to form the knob having an inwards receding snap zone formed by a curvature in the neck portion having a curvature radius smaller than 2.5 mm with a tolerance smaller than 0.25 mm and distanced from the axial centre with an average smallest diameter ranging between 19 mm and 30 mm such that a plastic base cap can be snapped onto the knob and form a stable connection therewith.

2. A method according to claim 1, wherein the PET preform is shaped with a proximal part having a first round circumference with a first circumferential length; and a recessed endcap having a second round circumference with a second circumferential length and wall thickness that is less than 90% of the first circumferential length.

3. A method according to claim 2, wherein the circumferential length 70-80% of the first circumferential length.

4. A method according to claim 1, wherein the PET preform is conically shaped.

5. A method according to claim 1, wherein the preform's narrowed distal end side is placed adjacent a flat surface in the mould so as to provide a flattened knob top surface.

6. A method according to claim 1, wherein the PET preform is formed by injection moulding.

7. A blow moulded PET container suitable for snap fitting a base cap; the PET container comprising a liquid compartment and a knob portion that is connected to the liquid compartment via a neck portion; the container having an axial centre for enabling a blow molding process according to claim 1; wherein the knob has a precursor central spot on a flattened end face, for allowing the plastic base cap to cover said central spot when snapped onto the knob, and wherein the knob comprises a circumference having an inwards receding snap zone formed by a curvature in the neck portion having a curvature radius smaller than 2 mm with a tolerance smaller than 0.25 mm with an average smallest diameter ranging between 19 mm and 30 mm such that a plastic base cap can be snapped onto the knob and form a stable connection therewith.

8. A blow moulded PET container according to claim 7, wherein the base cap comprises a hook for hanging the PET container, said hook being connected to the base cap through a film hinge, the base cap further comprising a hook-snap section onto which the hook can be stably snapped to form a smooth interface with the base cap.

9. A blow moulded PET container according to claim 6, wherein the knob top surface is flat.
